(19) United States
(12) Patent Application Publication
(10) Pub. No.: US 2025/0139558 A1
(43) Pub. Date: May 1, 2025

(54) SELLER INTELLIGENCE TOOL TO ASSESS CURRENT SALES AGENT POTENTIAL AND PROVIDE REVENUE POTENTIAL INSIGHTS

(71) Applicant: MINDTICKLE, INC., San Francisco, CA (US)

(72) Inventors: Aman BAFNA, Kota (IN); Dhruv MARKANDEY, Mountain View, CA (US); Krishna DEPURA, Pune (IN); Sunil CHANDRA, Pune (IN); Ajay DUBEY, Bhopal (IN); Abhinav BHATNAGAR, Pune (IN); Aniket GARG, Gurgaon (IN); Mihir SHEKHAR, Hyderabad (IN)

(21) Appl. No.: 18/498,923

(22) Filed: Oct. 31, 2023

(51) Int. Cl. G06Q 10/0637

(52) U.S. Cl. CPC G06Q 10/06375

(57) ABSTRACT

Systems, methods, and non-transitory computer-readable media for generating insights for increasing revenue including receiving past and current data on various metrics for a plurality of sale representatives for an organization; training a model to predict a potential revenue attainment based on the received data; calculating the potential revenue attainment for each of the plurality of sale representatives; selecting one representative; determining an impact of each performance metric, activity metric, competency metric, and execution/engagement metric on the potential revenue attainment; identifying one performance metric having the most impact on the potential revenue attainment; determining a correlation coefficient between each root cause metric and the identified one performance metric; identifying one root cause metric having the most impact on the identified one performance metric; and providing one or more recommendations for the one representative on an interactive sales dashboard based on the identified one root cause metric.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The present disclosure relates to providing the revenue achievement potential of sales representatives. Specifically, the present disclosure describes a methodology and process to predict the revenue attainment potential for sales representatives based on their current and past performance, and to generate actionable insights.

### BACKGROUND

Sales leaders are measured by their ability to achieve sales targets, which is dependent on revenue attainment by representatives. Currently, there is no visibility around revenue attainment. Typically, revenue is analyzed once the quarter is closed, but without granular root analysis and analysis of available leading indicators that showcase how effective the representatives are or separate the high achievers and consistent performers from outliers who met their sales quota due to exceptional events.

This lack of analysis leads to general lack of visibility on how ready the representatives really are, how they are performing in different sales stages, and what is needed to improve their performance. All of this information is critical for consistent revenue attainment every period.

Sales leaders have access to multiple tools that provide them insights on how their team is performing and help them forecast sales revenue numbers for the quarter or period. There is, however, no strong analytics component available in these tools that provides an end-to-end analysis of where the gaps are in the go-to-market (GTM) process and that provides insights to improve overall sales productivity.

Generally, the problem may be solved by collating all the data together from multiple sources and separately analyzing the data. This is time consuming and inefficient.

Accordingly, what is needed is a tool that brings together data points from multiple separately available sales tools in an automated fashion and provides data driven insights to sales leaders and sales teams.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is an exemplary data flow according to various aspects of the present disclosure.

FIG. 2 is an exemplary screenshot of an interactive sales dashboard according to various aspects of the present disclosure.

FIG. 3 is a flowchart of a method according to various embodiments of the present disclosure.

FIG. 4 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various software, machine learning, mechanical, compositional, structural, electrical, and operational changes may be made without departing from the spirit and scope of this description and the claims. In some instances, well-known machine logic, circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The presently disclosed systems and methods model the revenue achievement potential of each sales representative and the entire sales team through a unique blend of seller and deal signals, thereby generating actionable insights for success. By synergizing real-time seller feedback with pertinent deal information, the presently disclosed systems and methods deliver precise recommendations to improve representative readiness, to improve representative performance in different sales stages, and to improve their overall performance including in generating revenue. The present disclosure is directed to an intelligent platform that helps chief revenue officers (CROs) and sales leaders make informed decisions that yield immediate and long-term sales targets. With a laser focus on performance optimization, the present disclosure ensures sales teams are equipped to excel and surpass their goals. The presently disclosed systems and methods combine multiple signals from different areas (e.g., training, engagement with customers, call performance, and/or assets shared) and leverage both past and current data to accurately calculate the revenue potential of each sales representative.

It should be understood that while the present disclosure focuses on the performance of sales representatives, one of ordinary skill in the art recognizes that the present disclosure is applicable to assess performance potential of any employee outsides of sales representatives, as well, such as sales managers, sales trainers, R&D, IT, customer technical assistance, and the like. Specifically, the present systems and methods can be extended to assess the potential of employees belonging to any department or performing any function in an organization by bringing in data points relevant to their performance, competencies, activities, and behaviors.

According to one or more embodiments, the presently disclosed systems and methods analyze customer relationship management (CRM) data, along with seller and buyer signals to ascertain the relationship between what sellers are doing and the chances of securing a deal. In various embodiments, the presently disclosed systems and methods predict the revenue attainment potential for representatives based on their current and past performance. In several embodiments, the presently disclosed systems and methods aggregate revenue attainment potential at the team and organization level to provide inputs to sales leaders on future planning strategies.

Current revenue intelligence systems are mostly focused on highlighting the risks associated with current open deals by analyzing activity signals. These systems do not take into account competency levels of representatives and the quality of conversations they are having with their customers. Moreover, the analysis is at the deal level and is not aggregated to what happened over a longer time period, such as the course of a quarter or a year, to bring out patterns in multiple deals that are leading to consistent underperformance in certain areas.

Advantageously, the present disclosure describes an intelligent platform tool that can bring together competency, activity, and execution/engagement signals to provide a full picture of representative and team performance. In certain embodiments, the platform views all data points related to a sales team, including performance, training, activity, engagement and behavior. Moreover, the platform provides insights at the individual, team, and organization level to create a single place for the entire sales team to engage and increase performance. In one or more embodiments, the platform combines organizational insights with data from other companies of similar size and industry to create benchmarks and show what high performance looks like, or at least, provide recommendations to achieve higher performance. In some embodiments, the platform provides both retrospective data analysis on what went right and what went wrong in the previous period, and provides forward-looking recommendations to improve success rates and funnel conversion in the current and future periods.

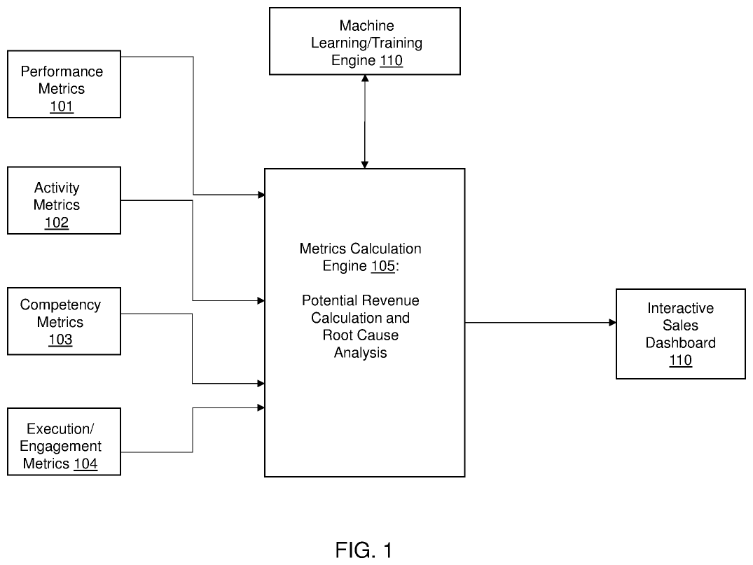

FIG. 1 illustrates a data flow according to one or more embodiments of the present disclosure. Data regarding performance metrics 101, activity metrics 102, competency metrics, and execution/engagement metrics 104 are collected and fed into the metrics calculation engine 105. In various embodiments, metrics calculation engine 105 takes any raw data that it receives and calculates the values of the metrics needed by machine learning/training engine 110 to train a model to predict potential revenue attainment for sales representatives. Machine learning/training engine 110 provides the trained model to metric calculation engine 105, which then determines the potential revenue attainment for sales representatives and performs root cause analysis on revenue attainment. Metric calculation engine 105 generates insights and recommendations, which are sent to interactive sales dashboard 110, where a sales leader or sales manager can review and decide to act on the insights and recommendations.

In several embodiments, the presently recited methods are broken down into a multi-step process.

Division of Sales Cycle into Stages

Every business defines certain sales stages to track the progress of a deal. In one or more embodiments, the presently recited methods take the specific sales stages of an organization and map it to a generic set of sales stages to define key metrics for each of these stages of the sales cycle. This facilitates the use of the same set of metrics for each organization despite each organization having different types of sales processes. In an exemplary embodiment, the sales cycle is divided into the following stages: prospecting, qualifying, value selling, negotiating, and closing. This can more easily permit comparison across different types of sales processes, or against an industry-wide metric, according to the present disclosure.

### Data Gathering

In certain embodiments, the platform gathers data from multiple sources, including both internal and external sources. In some embodiments, application programming interface (API) connections are created with all relevant sources. The data is then brought in and consolidated in a single data warehouse. The data generally includes data regarding performance metrics, activity metrics, competency metrics, and execution/engagement metrics.

In various embodiments, the platform collates data on sales representatives' performance over the past period through CRM tools or any other tool that captures deal details of the representatives' performance. Examples of performance metrics that may be collected include pipeline coverage sourced by the representative, volume and percentage qualified opportunities that reach the vendor of choice stage, volume and percentage opportunities that go from prove to vendor of choice stage, and volume and percentage opportunities that go from vendor of choice to closed/won stage.

In several embodiments, the platform takes data from any source(s) (e.g., CRM/sales engagement tools and/or content management systems) that captures the activities performed by sales representatives. For example, data can include any form of physical or virtual communication with customers such as calls, emails, messages, or meetings, and any assets such as decks, collaterals, or videos shared with the customer. Activity metrics include metrics that measure the effort representatives need to obtain traction with a customer. Examples of activity metrics include activity volume by the representative in pre-qualifying stage, activity volume by the representative in the qualify/discover stage, the number of assets shared in the quality/discover stage, activity volume by the representative to get to the vendor of choice stage, and daily sales report (DSR) activity in the vendor of choice stage.

In one or more embodiments, the platform takes data from any source(s) that measures the representative on required competencies for success (e.g., sales enablement tool). Such sources include any training or assessment tool or instructor-led training. Competency metrics include prospecting/business development, discovery/qualifying, consultative selling, objective handling, competitive takeout, negotiating and closing.

In some embodiments, the platform takes data from any source that measures the quality of execution in the representatives' interactions with the customer and how much engagement the customer is showing (e.g., conversation intelligence tool, coaching forms, peer feedback, and/or content management system). This data includes coverage of key items that help close the deal such as decision criteria and buy-in of economic buyer, handling objections, quality of conversations with the customer, and time spent by the customer on collaterals shared by representatives. Execution/engagement metrics include a prospecting call score, a prospecting call success rate (call to meetings ratio), time between opportunity creation and qualification, peer feedback, call score for first meeting, qualify stage asset engagement time between qualification and prove stage, call score on prove stage, prove stage asset engagement, time between prove stage and vendor of choice stage, sentiment analysis on objection handling, manager rating/coaching form, time between vendor of choice to close stage, and call score in closing stage.

In one or more embodiments, the data gathered is raw data relating to the metrics (rather than the value of the metrics), and the raw data is used to calculate the relevant metrics for the sales representatives. In various embodiments, the relevant metrics are aggregated at the team level and/or the organization level.

Table 1 below is an exemplary list of metrics that the platform may gather and analyze.

TABLE 1
EXAMPLE METRICS

| METRIC | MEANING |
|---|---|
| self-sourced deals | deals sourced by the representative themselves |
| allocated deals | deals allocated to the representative through marketing or partner |
| | channels |
| pipeline coverage | (total value of deals closed won or lost by the representative in a |
| | period)/(total quota plan of the representative) |
| revenue conversion of | (sum of amount of opportunities reaching next stage)/sum of |
| opportunities moving from | amount of opportunities reaching previous stage) |
| one stage to another | |
| opportunities (by number) | number of opportunities moving from previous stage to next stage |
| moving from one sales stage | |
| to next | |
| percentage of opportunities | percentage of opportunities moving from one stage to next stage |
| moving from one stage to | |
| next stage | |
| average deal size | average deal size of the opportunities won by the representative |
| new deal win rate | win rate of representatives in new logo opportunities: new logo |
| | opportunities that were closed won/total number of new logo |
| | opportunities |
| average deal cycle (new | average deal cycle (in days) for new logo opportunities won by |
| logo) | the representative |
| average deal cycle | average deal cycle (in days) for opportunities won by the |
| | representative |
| expansion deal win rate | win rate of representatives in expansion opportunities: expansion |
| | opportunities that were closed won/total number of expansion |
| | opportunities |
| average deal cycle | average deal cycle (in days) for expansion opportunities won by |
| (expansion) | the representative |
| representative win rate | win rate of representatives: opportunities that were closed won/ |
| | total number of opportunities |
| Baker Assessment Score | competency scores taken from the Baker Assessment |
| program competency scores | competency scores taken from program score/completion in |
| | Mindtickle |
| number of assets shared by | number of assets shared by representatives with customers in a |
| representatives | particular stage |
| number of assets | number of assets viewed/downloaded by customers in a particular |
| viewed/downloaded by | stage |
| customers | |
| call score | average call score of representatives across all calls in a particular |
| | stage |
| MEDDPICC score | score of representatives on all aspects of MEDDPICC (Metrics, |
| | Economic Buyer, Decision Process, Decision Criteria, Paper |
| | Process, Identify Pain, Champion, Competition) in a particular |
| | stage. This is done by analyzing the call transcripts through |
| | artificial intelligence (AI) |
| CHAMP score | score of reps on all aspects of CHAMP (Challenges, Authority, |
| | Money, Prioritization) in a particular stage. This is done by |
| | analyzing the call transcripts through AI. |
| objection handling | how well the representative has handled the questions asked by |
| | customers. This is done by analyzing the call transcripts through |
| | AI. |
| number of activity done by | number of activity done by representatives in reaching out to |
| representatives | customers in a particular stage. This includes calls, emails and |
| | meetings done with customers. |
| time taken between stages | average number of days taken by representatives to move an |
| | opportunity from one stage to another |
| time between customer | average number of days taken by representatives in 2 consecutive |
| reach-outs | reach-outs to customers |
| % opportunities touched | This checks whether the representative has done a reach-out on an |
| | account with an active opportunity in a month's time. For |
| | example, if a representative has 4 active opportunities and he has |
| | reached out to three of them in the past 1 month. Then his score |
| | will be 3/4 = 75% |
| number of items in a room | average number of items added to a digital sales room by a |
| | representative in a particular stage |
| total visits to a room | average number of visits to a digital sales room (DSR) by |
| | customers in a particular stage |
| unique visitors to a room | average number of unique visitors to a DSR in a particular stage |
| time spent by visitors in | average time spent by a visitor in DSR |
| DSR | |
| % DSR | percentage of opportunities with a digital sales room created for |
| | them (number of opportunities with a DSR room linked to them/ |
| | total number of opportunities of a representative) |
| % MAP | percentage of opportunities with a Mutual Action Plan (MAP) |
| | created in DSR (number of opportunities with a DSR room and |
| | MAP created in the DSR room/total number of opportunities of a |
| | representative) |
| MAP progress | average progress on MAP across all active DSR |
| CRM update frequency | Number of times a representative makes updates on CRM per |
| | opportunity |

### Model Training/Potential Revenue Calculation

In the training step of this embodiment, all the values of the metrics are standardized using standard deviation. Then the values of the metrics for a certain period (e.g., one year) are fed into the model for training the model. The model is trained to take the values of the metrics of a sales representative as input and to provide as output the potential revenue of the sales representative.

Once the model is trained to output potential revenue, in various embodiments, a suitable normalization technique is used to give each representative a score between 1-100 depending on their relative performance in each metric. In some embodiments, a weight for each metric is defined by regression analysis or by a predefined weight basis taken from industry knowledge. The current metric values for a sales representative are then fed into the trained model. The trained model then infers and provides the potential revenue for the sales representative as output. In certain embodiments, the potential revenue is aggregated at the team level and the organization level.

Along with training models for each company or organization, in one or more embodiments, a global model is trained in parallel, which digests data for all companies together to create an even more accurate model. In several embodiments, each company is slowly transitioned from their own model to the global model once the accuracy of the global model becomes higher than the company model.

In an exemplary embodiment, after collecting all the necessary values of metrics, the XGBoost algorithm is used to determine how likely each sales representative is to meet or exceed revenue goals. The XGBoost algorithm learns from past sales data and performance metrics. In simple terms, the XGBoost algorithm uses a series of decision trees or sets of yes or no questions about the data to make its predictions better and better. The algorithm starts with a basic guess for each sales representative's revenue potential and then refines that guess by looking at how far off it was from the actual results. This process repeats many times during training to improve accuracy.

Once the model is trained, it uses the latest values for performance, activity, execution/engagement, and competency metrics to estimate the current revenue potential for each sales representative. The algorithm also determines which performance metric(s), activity metric(s), competency metric(s), and/or execution/engagement metric(s) have the most impact on revenue. In various embodiments, the XGBoost algorithm determines the performance metric having the largest impact or influence on revenue potential through feature importance. Feature importance is typically output as a bar chart where the importance (or impact) of a feature is plotted versus the feature.

In one or more embodiments, the biggest area of improvement for a sales representative (when compared to his/her peers or a team average) is determined using the following formula:

Biggest area of improvement=Maximum of C×(D−E)over all performance metrics
Where C=Impact of respective performance metric on potential revenue attainment (from model training/potential revenue calculation)
D=Benchmark value of the respective performance metric (P75 value or value of top 25% of representatives)
E=Performance metric of representative

### Linking Performance Metric to Other Metrics

Once the impact of each performance metric is established, the impact of all the other metrics (activity metrics, competency metrics, and execution/engagement metrics) on these performance metrics is determined using correlation analysis. Activity, competency, and execution/engagement metrics are referred to herein as “root cause metrics.”

Correlation analysis is used to quantify the degree to which the performance metric and root cause metrics are related. Through correlation analysis, the correlation efficient can be evaluated, which informs how much a metric changes when the other metric does. The stronger the correlation, the closer the correlation coefficient comes to ±1. If the coefficient is a positive number, the metrics are directly related (as the value of one metric goes up, the value of the other metric also tends to do so). If the coefficient is a negative number, the metrics are inversely related (as the value of one metric goes up, the value of the other metric tends to go down).

In several embodiments, the root cause metric having the most impact on the performance metric(s) having the most impact on revenue is identified. Once the performance metric is identified, the root cause metric having the most impact on that performance metric is identified using the following formula:

Root cause metric having the most impact=Maximum of D×(A−B),
over all root cause metrics related to identified performance metric
Where D=Correlation of root cause metric and identified performance metric (from linking performance metric to other metrics)
A=Benchmark value of root cause metric (P75 value or value of top 25% of representatives) B=Root cause metric of representative

### Generation of Insights

In certain embodiments, the platform generates insights into areas of improvement for the sales representatives. In some embodiments, to improve revenue, the platform provides recommendations on how to increase the revenue potential for each representative, based on the performance metric identified as having the most impact on revenue and the root cause metric having the most impact on the identified performance metric.

In one embodiment, the potential revenue attainment generated by the model is plotted against actual revenue attainment to provide a 2×2 grid. The grid helps to identify key areas of improvement in terms of performance metrics for each representative to help him/her improve revenue attainment. CROs face issues in actually identifying their best performers compared to outliers who got lucky through a couple of deals, and among those who didn't achieve their quota, who needs to be nurtured and who may need to be terminated.

The 2×2 grid provides visibility on (1) which representatives/teams are high performers and can be leveraged to define winning behavior, (2) which representatives are doing all the right things, but are not able to achieve the sales quota, (3) which representatives are outliers and need coaching/enablement to achieve repeatable performance, and (4) which representatives need the most help to improve their performance. The grid, matrix, or graph allows sales leaders and managers to see how all the representatives measure against each other, and to identify the top performers.

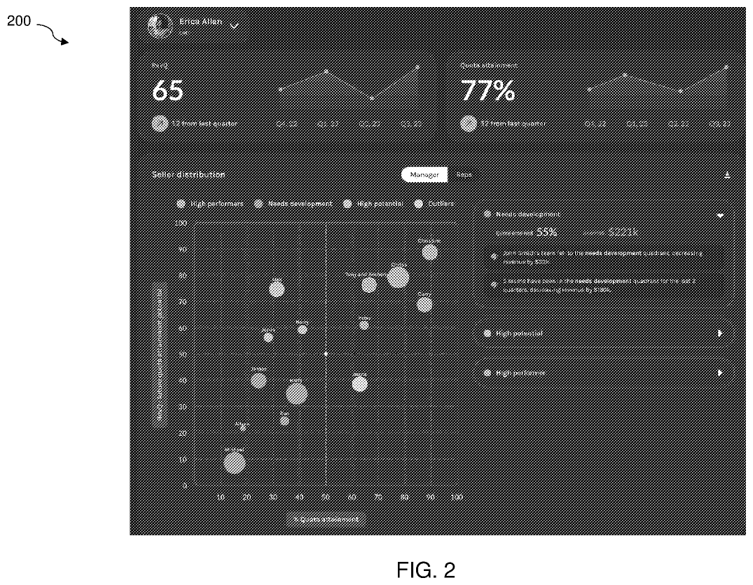

Referring now to FIG. 2, shown is an exemplary screenshot 200 of an interactive sales dashboard according to one or more embodiments of the present disclosure. As shown, the potential revenue attainment (or potential percent of sales quota achieved) is plotted against the actual revenue attainment (or actual percent of sales quota achieved). The 2×2 grid divides the sales representatives into four groups: high performers, those that need development, those that have high potential, and those that are outliers. In various embodiments, the sales representatives are color coded to indicate their group. For example, the higher performers may have a green color circle, the performers that need development may have a red color circle, the performers that have high potential may have a yellow color circle, and the outliers may have a white color circle, as displayed on the exemplary dashboard.

The high performers are in the upper right hand corner of the 2×2 grid. In various embodiments, the platform identifies these performers' repeatable behavior. The outliers are in the lower right hand corner of the 2×2 grid. In some embodiments, the platform identifies how to make the outlier's performance repeatable. The performers with high potential are in the upper left hand corner of the 2×2 grid. In several embodiments, the platform recommends coaching and persistence to help them reach their quota. The performers that need development are in the bottom left hand corner. In one or more embodiments, the platform recommends further practice and personalized training plans. In some cases, the platform may recommend probation, termination, or other employment action.

In an example, the platform reviews the following performance metrics for a sales representative: pipeline coverage, qualifying to prove stage conversion, prove stage to closing stage conversion, and closing stage to closed won conversion. These performance metrics are fed into the trained model, and the potential revenue for a sales representative is calculated as 40% of the quota. The actual revenue/quota attainment of the sales representative is 45%. Based on the 2×2 grid, the sales representative is in the needs quadrant.

From the model, the biggest area of improvement needed by the sales representative to improve revenue is pipeline coverage. The root cause metric having the highest impact on pipeline coverage is hunting competency for this particular sales representative. Using this information, sales leaders are able to highlight that the representative needs to work on improving his/her hunting competency to improve his/her revenue attainment. The platform enables the sales leader to assign the relevant training program to help the representative improve his/her hunting competency. The training can also help the representative take the correct actions during customer outreach.

In various embodiments, the model also analyzes colleagues of the representative. For example, the model examines all the representatives in the “needs development” quadrant and identifies key common traits across this group of representatives that leads to low or high performance. In some embodiments, the model identifies that the representatives in the “needs development” quadrant are all struggling with closing stage to closed won conversion, which has the biggest impact on their revenue attainment. The model then identifies the root cause metric that is causing the maximum impact on this performance metric as the number of customer outreaches done in the closing stage and highlights it as the key issue for this group of representatives. In certain embodiments, a user (e.g., sales leader or manager) of the platform selects a group of sales representatives from the 2×2 grid, and the platform displays additional information regarding the group.

After highlighting the areas where improvement is needed for a representative, a team, and/or an organization, the platform enables a sales leader or manager to assign the relevant training and coaching to the representative, team, and/or organization that will have the best chance of improvement. For example, the platform may allow the sales leader or manager to select one or more representatives, browse available training or coaching sessions, and select links or buttons to automatically assign the appropriate training. In several embodiments, the training or coaching sessions involve artificial intelligence (AI) driven contextual training exercises best suited to improve the performance of the sales representative. These exercises could be role play exercises based on the representative's identified gap, and/or training or coaching programs with calls to listen to or emulate other representatives who are doing well in that area of improvement.

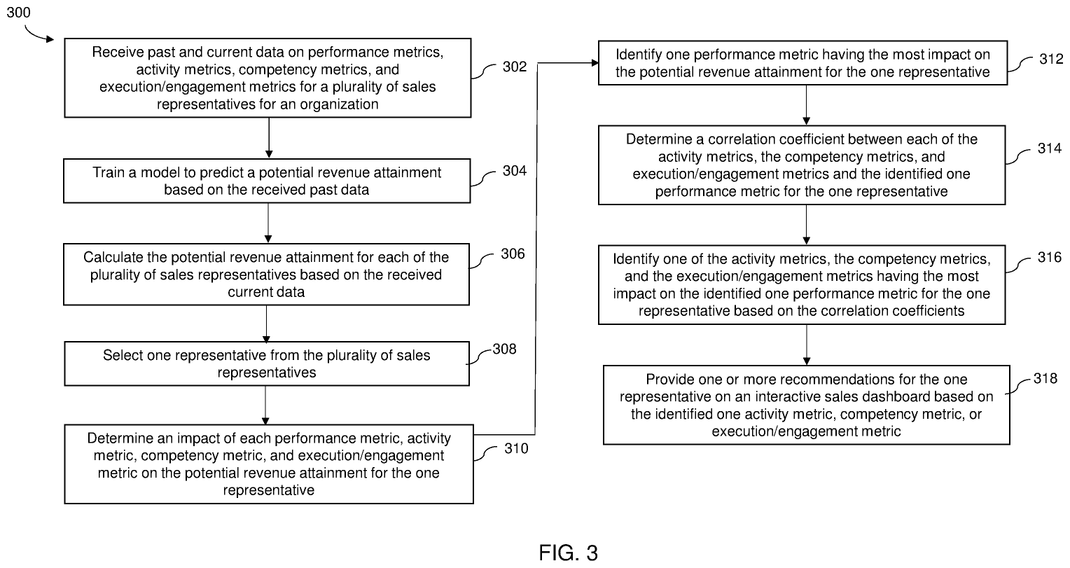

Turning now to FIG. 3, shown is a flowchart of a method 300 according to one or more embodiments of the present disclosure. At step 302, metrics calculation engine 105 receives past and current data on performance metrics, activity metrics, competency metrics, and execution/engagement metrics for a plurality of sale representatives for an organization from different internal and external sources.

At step 304, machine learner/training engine 110 trains a model to predict a potential revenue attainment based on the received data (i.e., historical or past data). In various embodiments, the model is the XGBoost algorithm.

At step 306, the trained model calculates the potential revenue attainment for each of the plurality of sale representatives based on the received data (i.e., current or recent data).

At step 308, metrics calculation engine 105 selects one representative from the plurality of sales representatives. It should be understood that in one or more embodiments, steps 308 to 318 are performed for each representative in an organization to determine how to improve performance throughout the organization.

At step 310, the trained model determines an impact of each performance metric, activity metric, competency metric, and execution/engagement metric on the potential revenue attainment for the one representative.

At step 312, metrics calculation engine 105 identifies the one performance metrics having the most impact on the potential revenue attainment for the one representative. At step 314, metrics calculation engine 105 determines a correlation coefficient between each of the root cause metrics (i.e., the activity metrics, the competency metrics, and the execution/engagement metrics) and the identified performance metric for the one representative.

At step 316, metrics calculation engine 105 identifies one root cause metric having the most impact on the identified one performance metric for the one representative based on the correlation coefficients. At step 318, metrics calculation engine 105 provides one or more recommendations for the one representative on an interactive sales dashboard based on the identified one root cause metric.

In one or more embodiments, method 300 further includes training and using a global model. In these embodiments, method 300 further includes receiving past and current data on performance metrics, activity metrics, competency metrics, and execution/engagement metrics for each of a plurality of sales representatives for a plurality of organizations; training a second model to predict a potential revenue attainment based on the received past data for the plurality of organizations; calculating, by the trained second model, the potential revenue attainment for each of the plurality of sale representatives based on the received current data for the plurality of organizations; selecting a second representative from the plurality of sales representatives; determining, by the second trained model, an impact of each performance metric, activity metric, competency metric, and execution/engagement metric on the potential revenue attainment for the second representative; identifying a second performance metric having the most impact on the potential revenue attainment for the second representative; determining a correlation coefficient between each of the activity metrics, each of the competency metrics, and each of the execution/engagement metrics, and the identified second performance metric for the second representative; identifying one of the activity metrics, the competency metrics, or the execution/engagement metrics having the most impact on the identified second performance metric for the second representative based on the correlation coefficients; and providing one or more recommendations for the second representative on an interactive sales dashboard based on the identified one activity metric, competency metric, or execution/engagement metric.

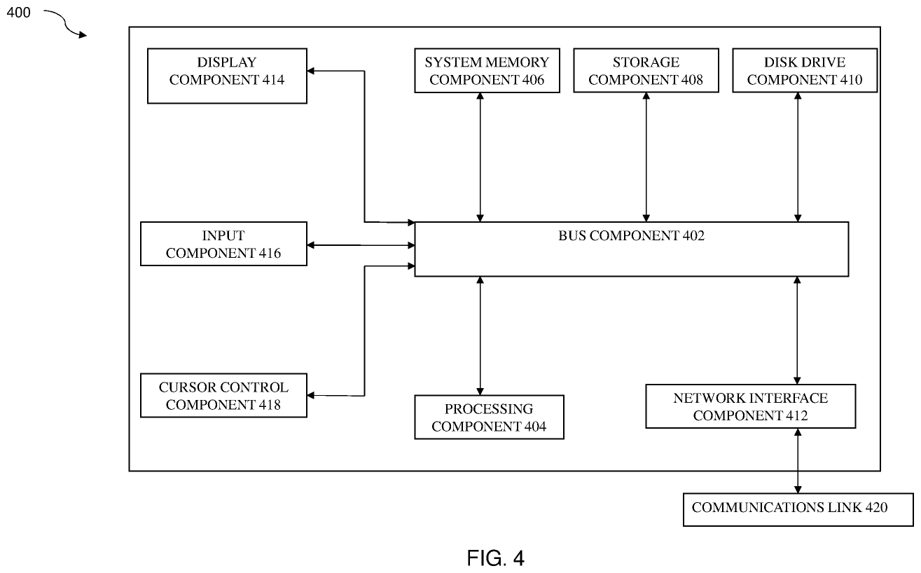

Referring now to FIG. 4, illustrated is a block diagram of a system 400 suitable for implementing embodiments of the present disclosure. System 400, such as part of a computer and/or a network server, includes a bus 402 or other communication mechanism for communicating information, which interconnects subsystems and components, including one or more of a processing component 404 (e.g., processor, micro-controller, digital signal processor (DSP), etc.), a system memory component 406 (e.g., RAM), a static storage component 408 (e.g., ROM), a network interface component 412, a display component 414 (or alternatively, an interface to an external display), an input component 416 (e.g., keypad or keyboard), and a cursor control component 418 (e.g., a mouse pad).

In accordance with embodiments of the present disclosure, system 400 performs specific operations by processor 404 executing one or more sequences of one or more instructions contained in system memory component 406. Such instructions may be read into system memory component 406 from another computer readable medium, such as static storage component 408. These may include instructions to receive past and current data on performance metrics, activity metrics, competency metrics, and execution/engagement metrics for a plurality of sale representatives; train a model to predict a potential revenue attainment based on the received data; calculate, by the trained model, the potential revenue attainment for each of the plurality of sale representatives based on the received data; select one representative from the plurality of sales representatives; determine, by the trained model, an impact of each performance metric, activity metric, competency metric, and/or execution/engagement metric on the potential revenue attainment for the one representative; identify one performance metric having the most impact on the potential revenue attainment for the one representative; determine a correlation coefficient between each of the activity metrics, each of the competency metrics, and each of the execution/engagement metrics and the identified one performance metric for the one representative; identify one of the activity metrics, the competency metrics, and the execution/engagement metrics having the most impact on the identified one performance metric for the one representative based on the correlation coefficients; and provide one or more recommendations for the one representative on an interactive sales dashboard based on the identified one activity metric, competency metric, or execution/engagement metric. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, volatile media includes dynamic memory, such as system memory component 406, and transmission media includes coaxial cables, copper wire, and fiber optics, including wires that comprise bus 402. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 400. In various other embodiments, a plurality of systems 400 coupled by communication link 420 (e.g., LAN, WLAN, PTSN, or various other wired or wireless networks) may perform instruction sequences to practice the disclosure in coordination with one another. Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

The Abstract at the end of this disclosure is provided to comply with 37 C.F.R. § 1.72 (b) to allow a quick determination of the nature of the technical disclosure. It is submitted with the understanding that it will not be used to interpret or limit the scope or meaning of the claims.

What is claimed is:

1. A revenue performance system comprising:
a processor and a computer readable medium operably coupled thereto, the computer readable medium comprising a plurality of instructions stored in association therewith that are accessible to, and executable by, the processor, to perform operations which comprise:
receiving past and current data on performance metrics, activity metrics, competency metrics, and execution/engagement metrics for each of a plurality of sales representatives for an organization;
training a model to predict a potential revenue attainment based on the received past data;
calculating, by the trained model, the potential revenue attainment for each of the plurality of sale representatives based on the received current data;
selecting one representative from the plurality of sales representatives;
determining, by the trained model, an impact of each performance metric, activity metric, competency metric, and execution/engagement metric on the potential revenue attainment for the one representative;
identifying one performance metric having the most impact on the potential revenue attainment for the one representative;
determining a correlation coefficient between each of the activity metrics, each of the competency metrics, and each of the execution/engagement metrics, and the identified one performance metric for the one representative;
identifying one of the activity metrics, the competency metrics, or the execution/engagement metrics having the most impact on the identified one performance metric for the one representative based on the correlation coefficients; and
providing one or more recommendations for the one representative on an interactive sales dashboard based on the identified one activity metric, competency metric, or execution/engagement metric.

2. The revenue performance system of claim 1, wherein identifying one of the activity metrics, the competency metrics, or the execution/engagement metrics having the most impact on the identified one performance metric for the one representative comprises determining a maximum value for:
$$D \times ( A - B ) ,$$
where D=correlation coefficient between an activity metric, a competency metric, or an execution/engagement metric and an identified performance metric,
A=benchmark value of the activity metric, the competency metric, or the execution/engagement metric, and
B=value of the activity metric, the competency metric, or the execution/engagement metric for the one representative.

3. The revenue performance system of claim 1, wherein the operations further comprise:
receiving past and current data on performance metrics, activity metrics, competency metrics, and execution/engagement metrics for each of a plurality of sales representatives for a plurality of organizations;
training a second model to predict a potential revenue attainment based on the received past data for the plurality of organizations;
calculating, by the trained second model, the potential revenue attainment for each of the plurality of sale representatives based on the received current data for the plurality of organizations;
selecting a second representative from the plurality of sales representatives;
determining, by the second trained model, an impact of each performance metric, activity metric, competency metric, and execution/engagement metric on the potential revenue attainment for the second representative;
identifying a second performance metric having the most impact on the potential revenue attainment for the second representative;
determining a correlation coefficient between each of the activity metrics, each of the competency metrics, and each of the execution/engagement metrics, and the identified second performance metric for the second representative;
identifying one of the activity metrics, the competency metrics, or the execution/engagement metrics having the most impact on the identified second performance metric for the second representative based on the correlation coefficients; and
providing one or more recommendations for the second representative on an interactive sales dashboard based on the identified one activity metric, competency metric, or execution/engagement metric.

4. The revenue performance system of claim 1, wherein the operations further comprise:
preparing a graph of potential revenue attainment versus actual revenue attainment for the plurality of sales representatives; and
displaying the graph on the interactive sales dashboard.

5. The revenue performance system of claim 4, wherein the graph groups the plurality of sales representatives into high performers, high potential performers, outliers, and performers needing development.

6. The revenue performance system of claim 5, wherein the operations further comprise:
receiving, via the interactive sales dashboard, a selection of a group of sales representatives from the graph; and
in response to receiving the selection, identifying common traits in the group that leads to high or low performance.

7. The revenue performance system of claim 4, wherein the operations further comprise:
receiving, via the interactive sales dashboard, a selection of a group of sales representatives from the graph; and
in response to receiving the selection, displaying additional information regarding the group.

8. The revenue performance system of claim 1, wherein the one or more recommendations comprises assigning a coaching or training session to the one representative.

9. The revenue performance system of claim 8, wherein the operations further comprise:
receiving, via the interactive sales dashboard, a selection of assigning the coaching or training session; and
in response to receiving the selection, automatically assigning the coaching or training session to the one representative.

10. A method of generating insights for increasing revenue, which comprises:
receiving past and current data on performance metrics, activity metrics, competency metrics, and execution/engagement metrics for each of a plurality of sales representatives for an organization;
training a model to predict a potential revenue attainment based on the received past data;
calculating, by the trained model, the potential revenue attainment for each of the plurality of sale representatives based on the received current data;
selecting one representative from the plurality of sales representatives;
determining, by the trained model, an impact of each performance metric, activity metric, competency metric, and execution/engagement metric on the potential revenue attainment for the one representative;
identifying one performance metric having the most impact on the potential revenue attainment for the one representative;
determining a correlation coefficient between each of the activity metrics, each of the competency metrics, and each of the execution/engagement metrics and the identified one performance metric for the one representative;
identifying one of the activity metrics, the competency metrics, and the execution/engagement metrics having the most impact on the identified one performance metric for the one representative based on the correlation coefficients; and
providing one or more recommendations for the one representative on an interactive sales dashboard based on the identified one activity metric, competency metric, or execution/engagement metric.

11. The method of claim 10, wherein identifying one of the activity metrics, the competency metrics, or the execution/engagement metrics having the most impact on the identified one performance metric for the one representative comprises determining a maximum value for:
$$D \times ( A - B ) ,$$
where D=correlation coefficient between an activity metric, a competency metric, or an execution/engagement metric and an identified performance metric,
A=benchmark value of the activity metric, the competency metric, or the execution/engagement metric, and
B=value of the activity metric, the competency metric, or the execution/engagement metric for the one representative.

12. The method of claim 10, which further comprises:
preparing a graph of potential revenue attainment versus actual revenue attainment for the plurality of sales representatives; and
displaying the graph on the interactive sales dashboard.

13. The method of claim 12, wherein the graph groups the plurality of sales representatives into high performers, high potential performers, outliers, and performers needing development.

14. The method of claim 13, which further comprises:
receiving, via the interactive sales dashboard, a selection of a group of sales representatives from the graph; and
in response to receiving the selection, identifying common traits in the group that leads to high or low performance, displaying additional information regarding the group, or both.

15. The method of claim 10, wherein the one or more recommendations comprises assigning a coaching or training session to the one representative.

16. A non-transitory computer-readable medium having stored thereon computer-readable instructions executable by a processor to perform operations which comprise:
receiving past and current data on performance metrics, activity metrics, competency metrics, and execution/engagement metrics for each of a plurality of sale representatives for an organization;
training a model to predict a potential revenue attainment based on the received past data;
calculating, by the trained model, the potential revenue attainment for each of the plurality of sale representatives based on the received current data;
selecting one representative from the plurality of sales representatives;
determining, by the trained model, an impact of each performance metric, activity metric, competency metric, and execution/engagement metric on the potential revenue attainment for the one representative;
identifying one performance metric having the most impact on the potential revenue attainment for the one representative;
determining a correlation coefficient between each of the activity metrics, each of the competency metrics, and each of the execution/engagement metrics and the identified one performance metric for the one representative;
identifying one of the activity metrics, the competency metrics, or the execution/engagement metrics having the most impact on the identified one performance metric for the one representative based on the correlation coefficients; and
providing one or more recommendations for the one representative on an interactive sales dashboard based on the identified one activity metric, competency metric, or execution/engagement metric.

17. The non-transitory computer-readable medium of claim 16, wherein identifying one of the activity metrics, the competency metrics, or the execution/engagement metrics having the most impact on the identified one performance metric for the one representative comprises determining a maximum value for:
$$D \times ( A - B ) ,$$
where D=correlation coefficient between an activity metric, a competency metric, or an execution/engagement metric and an identified performance metric,
A=benchmark value of the activity metric, the competency metric, or the execution/engagement metric, and
B=value of the activity metric, the competency metric, or the execution/engagement metric for the one representative.

18. The non-transitory computer-readable medium of claim 16, wherein the operations further comprise:
preparing a graph of potential revenue attainment versus actual revenue attainment for the plurality of sales representatives; and
displaying the graph on the interactive sales dashboard.

19. The non-transitory computer-readable medium of claim 16, wherein the one or more recommendations comprises assigning a coaching or training session to the one representative.

20. The non-transitory computer-readable medium of claim 19, wherein the operations further comprise:
receiving, via the interactive sales dashboard, a selection of assigning the coaching or training session; and
in response to receiving the selection, automatically assigning the coaching or training session to the one representative.
